(19) United States
(12) Patent Application Publication
(10) Pub. No.: US 2026/0113251 A1
(43) Pub. Date: Apr. 23, 2026

(54) NETWORK DIAGNOSTIC SYSTEMS AND METHODS

(71) Applicant: DISH Network L.L.C., Englewood, CO (US)

(72) Inventors: Shiqiang Chu, Highlands Ranch, CO (US); Kan Man Wong, Highlands Ranch, CO (US)

(21) Appl. No.: 18/924,730

(22) Filed: Oct. 23, 2024

(51) Int. Cl. H04L 41/22; H04L 41/12

(52) U.S. Cl. CPC H04L 41/22; H04L 41/12

(57) ABSTRACT

A disclosed method may include displaying, on a graphical user interface of a computing device used by a technician of the television service operator to assist a subscriber, a network topology representation that was generated based on extracted network diagnostic information as extracted from network messages received over a wide area network such that a television service operator is enabled to prevent or remediate a network connectivity alert within the subscriber's home network based on the displayed network topology representation.

### BRIEF SUMMARY

This disclosure is generally directed to systems, methods, and computer-readable media relating to network diagnostic technologies. In the evolving landscape of television and internet service provision, the complexity of home network setups has increased significantly. Subscribers often have multiple devices connected to their home networks, including media content servers, thin clients, smart TVs, and various streaming devices. This proliferation of connected devices may lead to a multitude of potential issues that may affect the quality of service experienced by subscribers. In some embodiments, traditional troubleshooting methods may require technicians to visit the subscriber's home, which may be time-consuming and costly for both the service provider and the subscriber. Additionally, on-site visits may not always be feasible or desirable, particularly in situations where immediate resolution is necessary or during times when in-person interactions are limited.

The increasing complexity of home networks may also make it challenging for customer support representatives to quickly and accurately diagnose issues remotely. In some examples, representatives may need to rely on verbal descriptions from subscribers who may not be technically savvy, potentially leading to misdiagnoses or inefficient troubleshooting processes. This situation may result in longer support call times, increased frustration for subscribers, and a higher likelihood of needing to escalate issues to more experienced technicians or schedule on-site visits.

Furthermore, the diverse range of devices and connection types present in modern home networks may make it difficult for support staff to maintain a comprehensive understanding of all possible configurations and their associated problems.

In some systems, network diagnostics tools may provide limited information about the status of a subscriber's network. These tools may focus on basic metrics such as connection status or signal strength, without offering a comprehensive view of the entire home network topology. This limited view may make it challenging for technicians to understand the full context of a reported issue, potentially leading to incomplete or ineffective solutions. Additionally, in some embodiments, existing diagnostic systems may not account for the interrelationships between different devices in the network, making it difficult to identify issues that stem from device interactions rather than individual device failures.

The dynamic nature of home networks may present additional challenges for service providers. Subscribers may frequently add, remove, or relocate devices within their network, potentially altering its performance characteristics. In some embodiments, these changes may not be immediately apparent to support staff, making it difficult to maintain an up-to-date understanding of the network's configuration. This lack of real-time information may hinder the ability of support representatives to provide accurate and timely assistance, potentially leading to increased resolution times and decreased customer satisfaction.

In some examples, service providers may face difficulties in proactively identifying and addressing network issues before they impact the subscriber's experience. Traditional reactive support models may only address problems after they have been reported by subscribers, potentially leading to service interruptions and dissatisfaction. The ability to predict and prevent issues before they occur may be limited by the lack of comprehensive, real-time data about the health and performance of subscriber networks. This reactive technique may result in higher support costs and missed opportunities to improve overall network reliability and customer satisfaction.

To address these challenges, some embodiments of the present disclosure may provide a comprehensive network diagnostic system that offers a visual representation of a subscriber's home network topology. This system may enable technicians to assess the overall structure and health of the network without the need for an on-site visit. In some embodiments, the system may present complex network information in an easily digestible format, enabling efficient remote troubleshooting and potentially reducing the need for in-home service calls.

The network topology representation may include detailed information about each device in the subscriber's network, including its connection type, signal strength, and current status. This comprehensive view may enable technicians to identify potential issues, such as devices with poor connections or those experiencing frequent disconnections. By providing this level of detail in a clear, visual format, the system may significantly improve the efficiency of remote troubleshooting, enabling technicians to focus on problematic areas of the network.

In some embodiments, the system may incorporate real-time updates of network status, enabling technicians to observe changes in the network as they occur. This feature may be particularly useful when guiding subscribers through troubleshooting steps, as the technician may immediately see the impact of any actions taken. Additionally, the real-time nature of the system may help identify intermittent issues that may be difficult to diagnose with static or periodic reporting tools.

The system may also include historical performance data, enabling technicians to identify patterns or recurring issues that may not be apparent from a single point-in-time view. This historical perspective may be valuable in diagnosing complex or intermittent problems, as well as in identifying trends that may indicate the need for network upgrades or proactive maintenance. In some embodiments, this historical data may be presented in various formats, such as graphs, calendars, or detailed logs, providing technicians with flexible tools for analysis.

Some embodiments of the system may incorporate predictive analytics capabilities, leveraging historical data and machine learning algorithms to forecast potential network issues before they impact the subscriber's service. This proactive technique may enable service providers to address problems preemptively, potentially reducing the number of support calls and improving overall customer satisfaction. The predictive features may also assist in capacity planning and network optimization, helping service providers to more efficiently allocate resources and improve network performance over time.

The system may integrate with existing customer support workflows, providing a seamless interface for technicians to access detailed network information while interacting with subscribers. This integration may potentially reduce the time needed to gather relevant information during support calls, enabling technicians to focus more on problem-solving and less on information gathering. In some examples, the system may also provide automated suggestions for troubleshooting steps based on the observed network state, potentially improving the consistency and effectiveness of support interactions.

In some embodiments, the system may support geolocation-based analysis, enabling service providers to identify patterns or issues affecting multiple subscribers in a specific geographic area. This feature may be particularly useful for diagnosing problems related to local infrastructure or environmental factors. By aggregating data from multiple subscribers, the system may potentially help service providers identify and address broader network issues more efficiently.

The network diagnostic system may also provide tools for comparing performance across different devices or subscribers, enabling technicians to benchmark performance and identify outliers that may require attention. This comparative analysis may be useful in identifying underperforming devices or configurations, as well as in setting realistic expectations for network performance based on observed data from similar setups.

In some embodiments, the system may support customizable alerts and thresholds, enabling service providers to tailor the system to their specific needs and priorities. This flexibility may enable proactive monitoring of key performance indicators and rapid response to critical issues. The alert system may potentially integrate with other support tools, such as ticketing systems or mobile apps, to ensure that the right personnel are notified of important events in a timely manner.

The network diagnostic system may potentially offer benefits beyond just troubleshooting. For example, the network topology information may be used to suggest optimizations or upgrades to subscribers, potentially improving their overall experience and increasing customer satisfaction. The system may also provide valuable data for product development teams, helping to identify common issues or desired features based on real-world usage patterns.

By addressing these various challenges and incorporating these features, the network diagnostic system described in this disclosure may improve the way television and internet service providers manage and support their subscribers'home networks. The comprehensive, visual technique to network diagnostics may enable more efficient troubleshooting, proactive issue prevention, and improved customer satisfaction, ultimately leading to a better experience for both subscribers and service providers.

In some examples, a method includes (i) extracting, by a server of a television service operator, network diagnostic information from network messages received over a wide area network from a plurality of devices within a subscriber's home network that includes at least one media content server and a set of media content clients that are connected to the wide area network through a home router such that the server generates, based on the extracted network diagnostic information, a network topology representation of the subscriber's home network that includes graphical representations of the plurality of devices and connections between the devices and that includes status indicators for each of the devices and connections based on the extracted network diagnostic information and (ii) displaying, on a graphical user interface of a computing device used by a technician of the television service operator to assist the subscriber, the network topology representation that was generated based on the extracted network diagnostic information as extracted from the network messages received over the wide area network such that the television service operator is enabled to prevent or remediate a network connectivity alert within the subscriber's home network based on the displayed network topology representation.

In some examples, the method further includes displaying, on the graphical user interface, changes to the network topology representation in real-time based on newly received network messages from the plurality of devices within the subscriber's home network.

In some examples, the method further includes displaying, on the graphical user interface, a historical view of the network topology representation over a specified time period that shows changes in the status indicators for the devices and connections over time.

In some examples, the method further includes highlighting, in the network topology representation, specific devices or connections with detected alerts based on predetermined error codes indicated in the network diagnostic information.

In some examples, the method further includes displaying, in response to a selection of a highlighted device or connection, additional diagnostic information for the selected device or connection.

In some examples, the method further includes displaying, on the graphical user interface, a list of predefined error codes associated with alerts in the network topology representation such that the technician is enabled to identify specific types of alerts within the subscriber's home network.

In some examples, the method further includes displaying, in the network topology representation, signal strength indicators for wireless connections between devices based on signal strength data indicated in the network diagnostic information.

In some examples, the method further includes displaying, in the network topology representation, connection type indicators that specify whether each connection between devices is a Wi-Fi connection, an Ethernet connection, or a MoCA (Multimedia over Coax Alliance) connection.

In some examples, the method further includes generating and displaying, on the graphical user interface, a prompt for resolving a detected alert based on the network topology representation and the network diagnostic information.

In some examples, the method further includes displaying, in the network topology representation, bandwidth usage information for each device and connection based on bandwidth data indicated in the network diagnostic information.

In some examples, the method further includes displaying, on the graphical user interface, software or firmware version information for each device in the subscriber's home network based on version data indicated in the network diagnostic information.

In some examples, the method further includes providing, on the graphical user interface, a search function that enables the technician to locate specific devices within the network topology representation based on device identifiers indicated in the network diagnostic information.

In some examples, the method further includes displaying, on the graphical user interface, a history of recent changes to a network configuration of the subscriber's home network based on configuration change data indicated in the network diagnostic information.

In some examples, the method further includes displaying, on the graphical user interface, a comparison between a current network topology representation and an ideal network topology for the subscriber's home network.

In some examples, the method further includes enabling, through the graphical user interface, remote rebooting of specific devices displayed in the network topology representation.

In some examples, the method further includes displaying, on the graphical user interface, a list of error categories associated with detected alerts in the network topology representation and providing, for each error category, a set of troubleshooting instructions that guides the technician through steps to resolve the associated alert.

In some examples, a non-transitory computer-readable medium has instructions stored thereon that, when executed by at least one physical computing processor, cause a computing device to perform operations comprising (i) extracting, by a server of a television service operator, network diagnostic information from network messages received over a wide area network from a plurality of devices within a subscriber's home network that includes at least one media content server and a set of media content clients that are connected to the wide area network through a home router such that the server generates, based on the extracted network diagnostic information, a network topology representation of the subscriber's home network that includes graphical representations of the plurality of devices and connections between the devices and that includes status indicators for each of the devices and connections based on the extracted network diagnostic information and (ii) displaying, on a graphical user interface of a computing device used by a technician of the television service operator to assist the subscriber, the network topology representation that was generated based on the extracted network diagnostic information as extracted from the network messages received over the wide area network such that the television service operator is enabled to prevent or remediate a network connectivity alert within the subscriber's home network based on the displayed network topology representation.

In some examples, a system comprises at least one physical computing processor of a computing device and a non-transitory computer-readable medium that has instructions stored thereon that, when executed by the at least one physical computing processor, cause the computing device to perform operations comprising (i) extracting, by a server of a television service operator, network diagnostic information from network messages received over a wide area network from a plurality of devices within a subscriber's home network that includes at least one media content server and a set of media content clients that are connected to the wide area network through a home router such that the server generates, based on the extracted network diagnostic information, a network topology representation of the subscriber's home network that includes graphical representations of the plurality of devices and connections between the devices and that includes status indicators for each of the devices and connections based on the extracted network diagnostic information and (ii) displaying, on a graphical user interface of a computing device used by a technician of the television service operator to assist the subscriber, the network topology representation that was generated based on the extracted network diagnostic information as extracted from the network messages received over the wide area network such that the television service operator is enabled to prevent or remediate a network connectivity alert within the subscriber's home network based on the displayed network topology representation.

### BRIEF DESCRIPTION OF THE DRAWINGS

For a better understanding of the present invention, reference will be made to the following Detailed Description, which is to be read in association with the accompanying drawings:

FIG. 1 shows a flow diagram for a method relating to network diagnostic systems and methods.

FIG. 2 illustrates a network topology representation of a subscriber's home network as it would appear in a graphical user interface used by a technician of a television service operator.

FIG. 3 presents a detailed device and connection information view, expanding on the network topology representation with specific performance metrics for each device.

FIG. 4 displays a historical network performance view, combining a monthly calendar of network events, a health error graph, and a current error list.

FIG. 5 shows a detailed network metrics view, providing comprehensive tables of network performance data for specific devices in the subscriber's home network.

FIG. 6 presents a network error analysis and troubleshooting view, combining a list of current network errors with a step-by-step troubleshooting guide.

FIG. 7 offers a network performance comparison view, enabling technicians to compare performance across multiple devices over time.

FIG. 8 illustrates a geolocation-based network analysis view, presenting network performance across multiple subscribers in a specific geographic area.

FIG. 9 shows a predictive network maintenance view, combining a timeline of predicted events with a maintenance recommendation panel.

FIG. 10 displays a customer support integration view, demonstrating how the network health monitoring system can be integrated into the customer support workflow.

FIG. 11 shows a diagram of an example computing system that may facilitate the performance of one or more of the methods described herein.

### DETAILED DESCRIPTION

The following description, along with the accompanying drawings, sets forth certain specific details in order to provide a thorough understanding of various disclosed embodiments. However, one skilled in the relevant art will recognize that the disclosed embodiments may be practiced in various combinations, without one or more of these specific details, or with other methods, components, devices, materials, etc. In other instances, well-known structures or components that are associated with the environment of the present disclosure, including but not limited to the communication systems and networks, have not been shown or described in order to avoid unnecessarily obscuring descriptions of the embodiments. Additionally, the various embodiments may be methods, systems, media, or devices. Accordingly, the various embodiments may be entirely hardware embodiments, entirely software embodiments, or embodiments combining software and hardware aspects.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and enables for being based on additional features, functions, aspects, or limitations not described, unless the context clearly dictates otherwise. In addition, throughout the specification, the meaning of “a,”“an,” and “the” include singular and plural references.

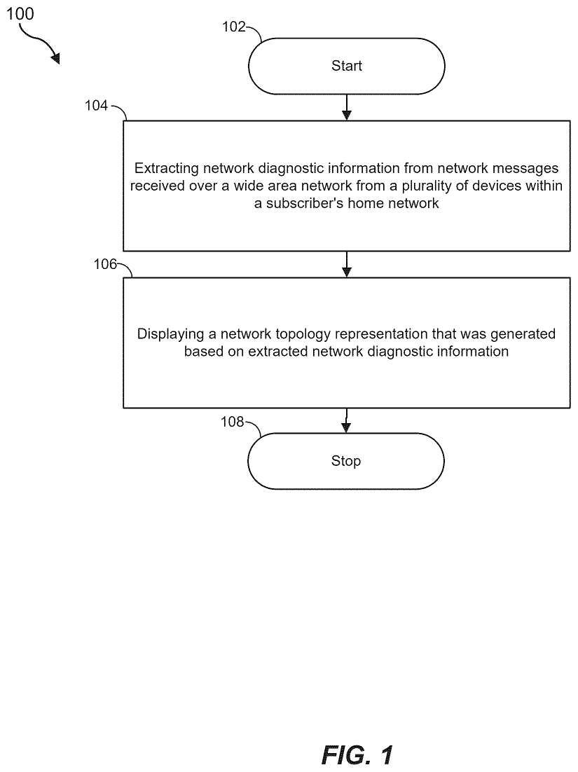

FIG. 1 shows a flow diagram for a method 100 relating to cellular coverage acquisition. At step 102, method 100 may start. At step 104, method 100 includes extracting, by a server of a television service operator, network diagnostic information from network messages received over a wide area network from a plurality of devices within a subscriber's home network that includes at least one media content server and a set of media content clients that are connected to the wide area network through a home router such that the server generates, based on the extracted network diagnostic information, a network topology representation of the subscriber's home network that includes graphical representations of the plurality of devices and connections between the devices and that includes status indicators for each of the devices and connections based on the extracted network diagnostic information. At step 106, method 100 includes displaying, on a graphical user interface of a computing device used by a technician of the television service operator to assist the subscriber, the network topology representation that was generated based on the extracted network diagnostic information as extracted from the network messages received over the wide area network such that the television service operator is enabled to prevent or remediate a network connectivity alert within the subscriber's home network based on the displayed network topology representation. At step 108, method 100 ends.

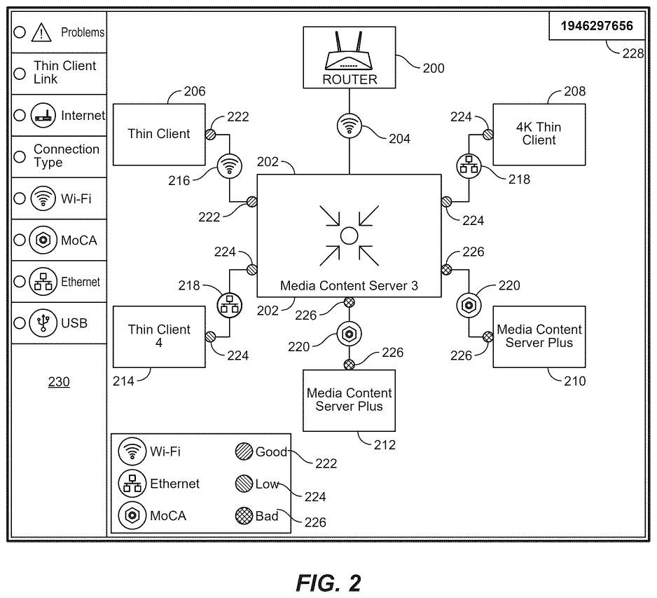

FIG. 2 illustrates a network topology representation of a subscriber's home network as it may appear in the graphical user interface used by a technician of the television service operator. This representation provides a comprehensive view of the subscriber's home network, enabling technicians to assess the overall network structure and health without the need for an in-home visit. At the top-left of the diagram, router 200 may represent the primary internet connection point for the subscriber's home network. In some embodiments, router 200 may serve as the gateway between the local network and the wider internet, managing data traffic and providing both wired and wireless connectivity options for various devices, including those used for television services. Below router 200, media content server 3 202 represents the main device in the network. Media content server 3 202 may serve as a distribution point for media content within the home network, acting as an intermediary between the internet connection and the various client devices. This type of setup may be used in some households, where a central device manages and distributes television and other media content to multiple endpoints throughout the house. In some examples, method 100 may further include updating the network topology representation in real-time based on newly received network messages from the plurality of devices within the subscriber's home network.

A line connects router 200 to media content server 3 202, with Wi-Fi symbol 204 placed on this line. Wi-Fi symbol 204 may indicate that media content server 3 202 is connected to router 200 via a wireless connection. The choice between wired and wireless connections for devices like media content server 3 202 may impact network performance and reliability, which may be helpful for delivering high-quality television services. Surrounding media content server 3 202, five smaller icons represent client devices, arranged in a circular pattern. These devices include “thin client” 206, “4K thin client” 208, two “media content server plus” devices 210, 212, and “thin client 4” 214. Each of these client devices 206, 208, 210, 212, 214 is connected to media content server 3 202 by lines, representing the network connections between them. The variety of client devices illustrates a diverse ecosystem of home entertainment systems, where different devices may serve specialized purposes such as high-definition video playback or secondary content distribution for television services. Next to each connection line, small icons represent the type of connection between devices. These icons include Wi-Fi symbols 216 for wireless connections, cable-with-plug icons 218 for wired Ethernet connections, and coaxial cable connector icons 220 for MoCA (Multimedia over Coax Alliance) connections. In some examples, this variety of connection types may illustrate the flexibility of the home network setup, accommodating different device capabilities and placement requirements within the home. The use of multiple connection types may help optimize network performance by utilizing appropriate technology for each device's needs and location within the home, potentially ensuring smooth delivery of television content. In view of the above, in some embodiments, method 100 may include displaying, in the network topology representation, signal strength indicators for wireless connections between devices based on signal strength data indicated in the network diagnostic information.

The health status of each device and connection is indicated by differently shaded dots: good status 222, low or warning status 224, and bad or error status 226. These shaded indicators may enable technicians to identify potential issues within the network, enabling them to focus their attention on devices or connections that may require attention. This visual representation of network health provides technicians with an overview of the subscriber's network status, which may be beneficial for efficient troubleshooting of television service issues. A legend at the bottom-left of the diagram explains the meaning of the Wi-Fi, Ethernet, and MoCA icons, as well as the shaded status indicators. This legend may provide information about the iconography used in the interface, potentially ensuring that technicians can interpret the visual data presented. In the top-right corner of the diagram, text box 228 displays “1946297656”, representing the customer ID. This display of the customer ID may enable technicians to confirm that they are viewing the correct subscriber's network information, which may be beneficial for accurate diagnostics and troubleshooting of television service-related issues. In some embodiments, method 100 may include highlighting, in the network topology representation, specific devices or connections with detected alerts based on predetermined error codes indicated in the network diagnostic information. In view of the above, in some embodiments, method 100 may include providing, on the graphical user interface, a search function that enables the technician to locate specific devices within the network topology representation based on device identifiers indicated in the network diagnostic information.

On the left side of the diagram, a vertical list of selectable tabs 230 is shown, including options such as “Problems”, “Thin Client Link”, “Internet”, “Connection Type”, “Wi-Fi”, “MoCA”, “Ethernet”, and “USB”. These tabs may enable technicians to access different aspects of the network information, enabling them to focus on specific areas of interest. The ability to switch between different views of the network data may provide options in how technicians approach troubleshooting and network analysis, potentially improving the efficiency and effectiveness of their work in resolving television service issues. In some embodiments, this visual representation may enable technicians to understand the subscriber's home network setup without needing to be physically present in the home. By providing this level of detail in a visual format, the system may improve the efficiency of remote troubleshooting for television services. Technicians may use selectable tabs 230 to identify structural issues, such as connections or device placements, as well as performance issues indicated by the status dots. The ability to see the types of connections between devices (Wi-Fi, Ethernet, MoCA) may be particularly useful in troubleshooting television service problems. For example, if a thin client device with a Wi-Fi connection is experiencing issues with video streaming, the technician may suggest moving it closer to the router or switching to a wired connection if possible. Similarly, understanding which devices are using MoCA connections may help in diagnosing issues related to coaxial cable quality or interference that may affect television signal quality.

The interface may provide a comprehensive tool for technicians to grasp the layout and status of a subscriber's home network, potentially leading to faster resolution of television service issues and improved customer support experiences. By consolidating various network elements into a single, visual representation, the system aims to streamline the troubleshooting process and provide technicians with the information they need to effectively address network issues remotely, ultimately ensuring a better television viewing experience for the subscriber. This visual representation may enable technicians to quickly assess the overall health of the network, identify potential bottlenecks or weak points, and make informed decisions about troubleshooting steps or recommendations for network improvements. The combination of device icons, connection types, and status indicators provides a rich set of information that may be helpful for understanding the complexities of modern home entertainment networks. By offering this level of detail in an easily digestible format, the system may enable technicians to provide more accurate and efficient support, potentially reducing the need for in-home visits and improving the overall customer experience with the television service.

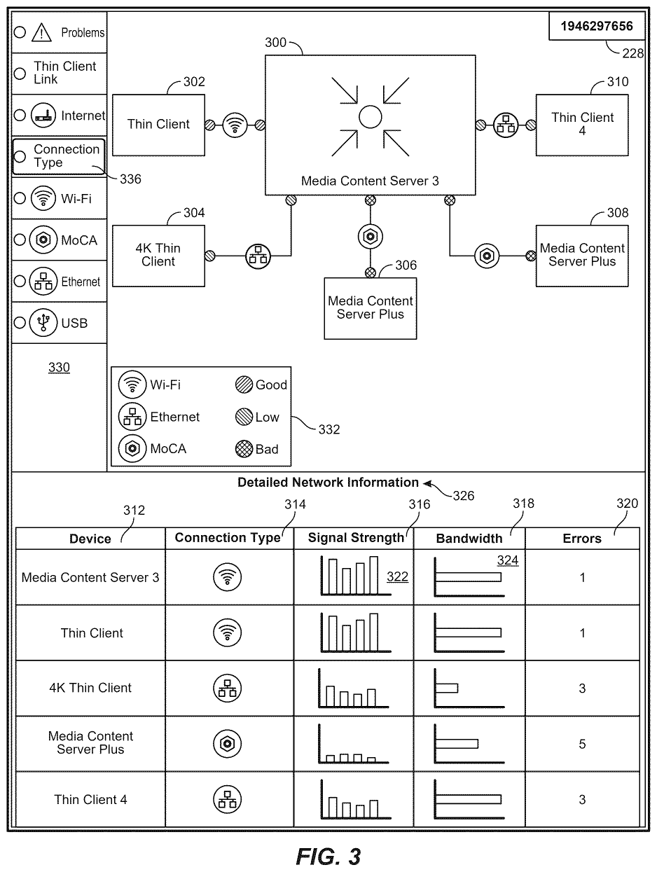

FIG. 3 presents a detailed device and connection information view, expanding on the network topology representation with specific performance metrics for each device in a subscriber's home network. This figure may be divided into two main sections: a larger upper section and a smaller lower section, providing a comprehensive overview of the network's status and performance. In the upper section of FIG. 3, a simplified version of the network topology from FIG. 2 is recreated, with some modifications to emphasize certain elements. Media content server 3 300 is depicted as a larger, more central icon, highlighting its role in the network. Surrounding the media content server 3 300, client device icons 302, 304, 306, 308, 310 are arranged in a semicircle, representing various thin clients and media content server plus devices. Connection lines between media content server 3 300 and each client device are clearly visible, with the same connection type icons (Wi-Fi, Ethernet, MoCA) used in FIG. 2 to indicate the nature of each connection. This visual representation may enable technicians to quickly grasp the overall structure of the home network while providing a context for the more detailed information presented in the lower section of the figure. The simplified topology in the upper section may serve as a visual reference point, enabling technicians to correlate the detailed metrics in the lower section with the physical layout and connections of the network devices.

The lower section of FIG. 3 contains a table-like structure that displays detailed information about each device in the network. This table is divided into several columns, each providing specific metrics that may be helpful for diagnosing network issues and assessing overall performance. “Device” column 312 lists the names of all devices shown in the topology, such as “Media Content Server 3”, “Thin Client”, “4K Thin Client”, and others. This device column 312 serves as a reference point, enabling technicians to easily correlate the detailed information with the devices shown in the upper section. In“Connection Type” column 314, the same icons used in the topology diagram (Wi-Fi, Ethernet, MoCA) are displayed for each device, providing a quick visual indication of how each device is connected to the network. This information may be particularly useful when assessing potential issues related to specific connection types or when considering recommendations for optimizing network performance. “Signal Strength” column 316 displays simple bar graphs 322 to represent the signal strength for each device. These graphs may use three to four bars filled to different levels, providing an intuitive visual representation of signal quality. For wireless devices, this metric may be especially helpful in identifying potential issues related to distance from the router or interference. “Bandwidth” column 318 displays horizontal bar graphs 324 of varying lengths represent bandwidth usage for each device. This visual representation may enable technicians to quickly identify which devices are consuming the most network resources, potentially helping to diagnose issues related to network congestion or slow performance on specific devices. “Errors” column 320 uses numerical values to represent error counts for each device. This information may be valuable for identifying devices that are experiencing frequent issues, which may require further investigation or troubleshooting. The combination of these different metrics in a single table may provide technicians with a comprehensive view of each device's performance and status, enabling more efficient and accurate diagnosis of network issues. In some embodiments, method 100 may include displaying, in response to a selection of a highlighted device or connection, additional diagnostic information for the selected device or connection.

At the top of the diagram, a title reading “Detailed Network Information” 326 is displayed, clearly indicating the purpose of this figure to viewers. In the top-right corner, the same customer ID text box 228 from FIG. 2 is included, ensuring consistency and enabling technicians to confirm they are viewing information for the correct subscriber. On the left side of FIG. 3, the same simplified tab list 330 from FIG. 2 is shown, but with the “Connection Type” tab highlighted or emphasized to indicate it's selected. This visual cue may help technicians understand the context of the information being displayed and how it relates to other aspects of the network diagnostic system. The combination of the simplified network topology and the detailed performance metrics in FIG. 3 may provide technicians with a powerful tool for diagnosing and resolving network issues. By presenting both high-level structural information and specific device-level metrics in a single view, this figure may enable more efficient and effective troubleshooting. For example, if a subscriber reports poor video quality on a specific thin client, the technician may quickly identify the device in the topology view, check its connection type, and then examine its signal strength, bandwidth usage, and error count in the detailed table. This comprehensive view may enable the technician to determine if the issue is related to a weak Wi-Fi signal, network congestion, or device-specific errors. The bandwidth usage information may be particularly helpful in embodiments where multiple devices are streaming content simultaneously. If one device is consuming a disproportionate amount of bandwidth, it may impact the performance of other devices on the network. The visual representation of bandwidth usage may make it easier for technicians to identify such situations and suggest appropriate solutions, such as adjusting streaming quality settings or upgrading the subscriber's internet plan. The error count information may help identify devices that are experiencing frequent issues, which may not be immediately apparent from the network topology view alone. A device with a high error count may require further investigation, such as checking for software updates, examining physical connections, or potentially replacing the device if it is found to be faulty.

By providing this level of detail in a clear, visual format, FIG. 3 may significantly improve the efficiency of remote troubleshooting for television services. Technicians may be able to quickly identify potential issues, correlate problems across multiple devices, and make data-driven decisions about how to resolve subscriber complaints. This technique may lead to faster problem resolution, reduced need for in-home visits, and ultimately, improve customer satisfaction with the television service. The detailed information presented in FIG. 3 may also be useful for proactive network management and optimization. By regularly monitoring the performance metrics of each device, technicians may be able to identify trends or potential issues before they become noticeable to the subscriber. For example, a gradual decrease in signal strength for a particular device may indicate a developing problem that may be addressed preemptively. Similarly, consistent high bandwidth usage on certain devices may suggest the need for network upgrades or reconfiguration to better distribute the load. The error count information may be used to identify devices that may be approaching the end of their lifecycle or requiring maintenance, enabling for planned replacements or upgrades rather than reactive problem-solving. In addition to troubleshooting and proactive management, the information presented in FIG. 3 may be valuable for customer education and service improvement. Technicians may use the visual representations of signal strength and bandwidth usage to explain network concepts to subscribers, helping them understand how their usage patterns and device placements may impact their overall experience. This educational aspect may lead to more informed subscribers who can better manage their home networks and potentially reduce the frequency of support calls. Furthermore, the aggregated data from multiple subscriber networks may provide valuable insights for the television service provider, informing decisions about network infrastructure investments, product development, and service offerings. By analyzing patterns in device performance, connection types, and error rates across many households, the provider may identify opportunities for service improvements or new features that may enhance the overall quality of their television service offering.

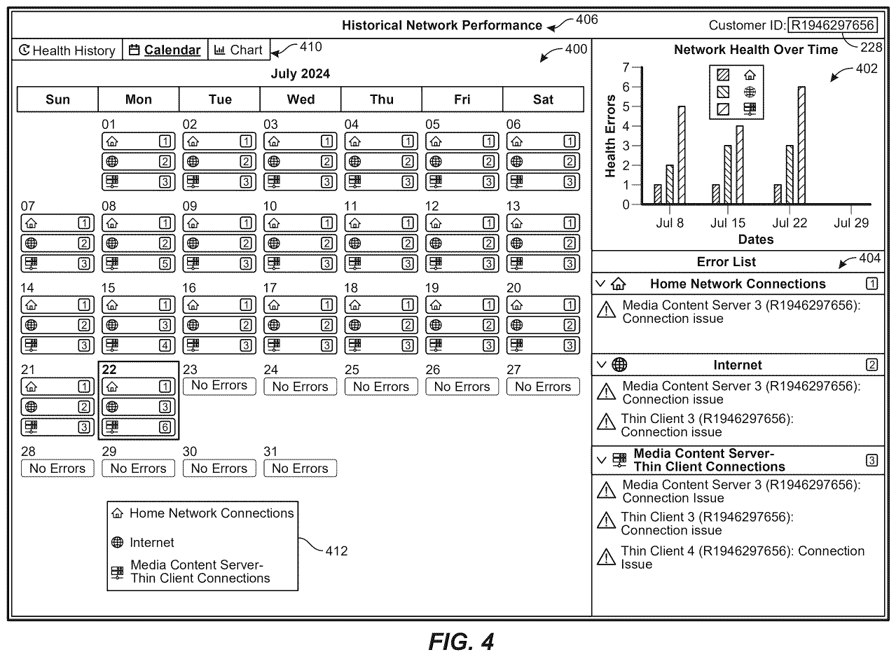

FIG. 4 illustrates a historical network performance view that combines a monthly calendar of network events, a health error graph, and a current error list. This comprehensive display may provide technicians with valuable insights into the patterns and trends of network issues over time, potentially enabling more effective troubleshooting and proactive maintenance of subscribers' home networks. The figure is divided into three main sections: calendar 400 on the left, graph 402 in the top right, and error list 404 in the bottom right. This layout may enable technicians to simultaneously view different aspects of the network's historical performance, facilitating a more holistic understanding of the subscriber's network health over time. Calendar 400 displays a large monthly calendar occupying about two-thirds of the page width and the full page height is displayed. At the top of calendar 400, the month is labeled as “July 2024”, providing a clear temporal context for the information presented. Each date cell within calendar 400 contains small icons representing different types of network events. These icons include a house icon for “Home Network Connections,” a globe icon for “Internet” issues, and a link icon for “Media Content Server-Thin Client Connections.” The use of these distinct icons may enable technicians to quickly identify the types of issues that have occurred on specific dates. Adjacent to each icon in the calendar section 400, a number is displayed to represent the count of events for that particular category on that day. For dates with no recorded errors, the cell contains the text “No Errors” in small print. This detailed calendar view in calendar 400 may enable technicians to identify patterns in network issues, such as recurring problems on specific days of the week or clusters of issues around particular time periods. Such insights may be helpful in diagnosing intermittent problems or correlating network issues with external factors like scheduled maintenance or peak usage times. In view of the above, in some embodiments, method 100 may include displaying, on the graphical user interface, a history of recent changes to a network configuration of the subscriber's home network based on configuration change data indicated in the network diagnostic information.

The graph 402 in the top right corner of FIG. 4 presents a bar graph representing network health over time. The X-axis of graph 402 is labeled with dates (e.g., “Jul 8”, “Jul 15”, etc.), corresponding to the weeks shown in the calendar 400. The Y-axis of graph 402 is labeled “Health Errors” with values ranging from 0 to 7, providing a quantitative measure of network issues. Each bar in graph 402 uses different shadings or patterns to represent different types of errors, corresponding to the icons used in the calendar section 400. This visual representation in graph 402 may enable technicians to quickly assess the overall health of the network over time and identify any significant spikes in error rates. Graph 402 may reveal trends that may not be immediately apparent from the calendar view in calendar 400 alone, such as gradual increases in certain types of errors or cyclical patterns in network health. By correlating the information in the graph 402 with the calendar view in calendar 400, technicians may be able to gain deeper insights into the nature and frequency of network issues. For example, a spike in errors on the graph in graph 402 may prompt the technician to examine the corresponding date in the calendar 400 for more detailed information about the types of issues that occurred. This combination of high-level trend data in graph 402 and detailed daily information in calendar 400 may enhance the technician's ability to diagnose complex or recurring network problems.

Error List 404 at the bottom right of FIG. 4 provides a current snapshot of network issues. Error list 404 uses the same icons as the calendar 400 (house, globe, link) to categorize the errors, maintaining visual consistency across the different components of the figure. For each category in error list 404, one or two specific errors are listed, along with the associated device IDs. For example, an entry in error list 404 may read “Media Content Server 3 (R1946297656): Connection issue.” The list in error list 404 may serve several purposes in the context of the historical view. First, it provides immediate context for any ongoing issues, enabling technicians to quickly assess the current state of the network. Second, it may help in correlating current problems shown in error list 404 with historical patterns visible in the calendar 400 and graph 402. If a current issue listed in error list 404 is part of a recurring pattern visible in calendar 400 and graph 402, this may inform the technician's troubleshooting technique. Additionally, the inclusion of specific device IDs in the error list 404 may enable technicians to quickly identify problematic devices that may require focused attention or replacement. The combination of historical data in calendar 400 and graph 402 and current status information in error list 404 in a single view may significantly enhance a technician's ability to provide effective and efficient support.

At the top of FIG. 4, a title reading “Historical Network Performance” 406 is displayed, clearly indicating the purpose and content of the figure to viewers. In the top-right corner, text box 228 displays “1946297656”, representing the customer ID ensuring consistency with other figures and enabling technicians to confirm they are viewing information for the correct subscriber. On the left side of the figure, tab list 410 is shown, with the “Calendar” tab highlighted to indicate it's selected. Tab list 410 may provide context for how the historical view fits into the broader network diagnostic system and may enable technicians to easily navigate between different types of network information. The historical performance view presented in FIG. 4 may offer several benefits for network diagnostics and customer support. By providing a long-term perspective on network health through calendar 400, graph 402, and error list 404, it may enable technicians to identify slow-developing issues that may not be apparent in real-time monitoring. For example, a gradual increase in connection issues over several weeks may indicate a deteriorating piece of hardware or a developing interference problem. The ability to correlate different types of errors over time using the calendar 400 and graph 402 may also help in identifying root causes of network problems. If internet connectivity issues consistently precede media content server connection problems, for instance, this may suggest a cascading failure pattern that requires attention at the internet connection level. Furthermore, the historical view provided by FIG. 4 may be helpful in verifying the effectiveness of previously applied solutions. After implementing a fix, technicians can monitor the calendar 400 and graph 402 to ensure that the issue doesn't recur and that overall network health improves as expected.

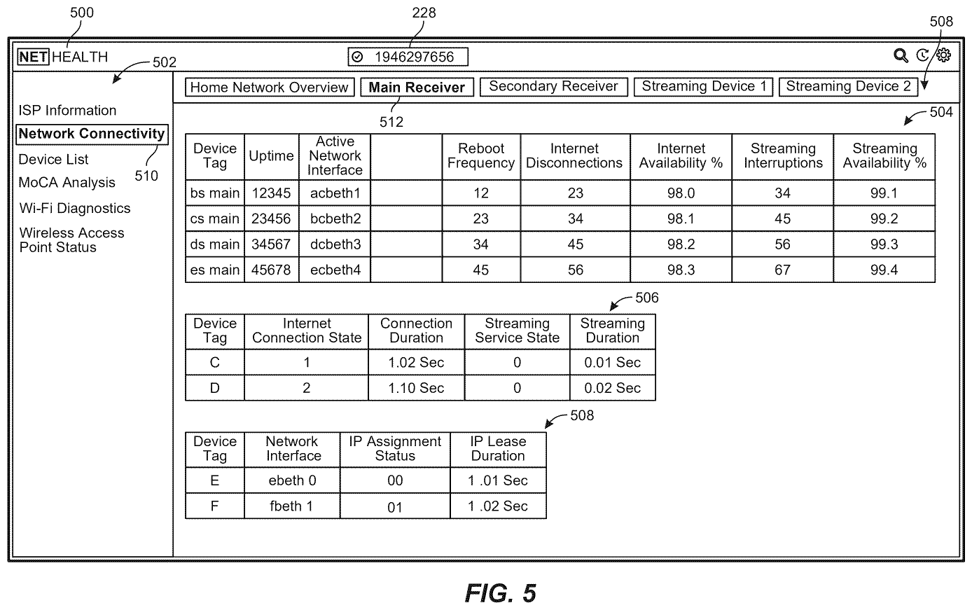

FIG. 5 presents a detailed network metrics view, providing comprehensive tables of network performance data for specific devices in the subscriber's home network. This figure is divided into three main sections: header 500 at the top, navigation menu 502 on the left, and main content area 504 taking up most of the page. The layout of FIG. 5 is designed to offer technicians a wealth of technical information in an organized and easily navigable format, potentially enabling more efficient and thorough network diagnostics.

In the header 500, a logo placeholder labeled “NET HEALTH” is displayed at the top left, immediately establishing the context of the diagnostic tool. Adjacent to the logo, text box 228 contains the customer ID “1946297656”, ensuring that technicians can quickly verify they are viewing the correct subscriber's information. This consistent display of the customer ID across different views of the diagnostic tool may help prevent errors and confusion during troubleshooting sessions. On the right side of the header 500, simple icons for search, time, and settings are included. These icons may provide quick access to additional functionalities within the diagnostic tool, potentially enabling technicians to perform searches, check timestamps of data, or adjust system settings as needed during their analysis.

The navigation menu 502 on the left side of FIG. 5 contains a vertical list of items that may represent different aspects or modules of the network diagnostic system. This list in navigation menu 502 includes options such as “ISP Information,” “Network Connectivity,” “Device List,” “MoCA Analysis,” “Wi-Fi Diagnostics,” and “Wireless Access Point Status.” The “Network Connectivity” item 510 in the navigation menu 502 is highlighted, indicating that it's the currently selected view. Navigation menu 502 may enable technicians to quickly switch between different aspects of network diagnostics, providing a comprehensive toolkit for analyzing various components of the subscriber's home network. The clear organization and labeling of the navigation options in navigation menu 502 may help streamline the diagnostic process, enabling technicians to efficiently access the specific information they need for each troubleshooting scenario.

Main content area 504 presents detailed network metrics in a tabular format. The large table structure in main content area 504 is divided into several columns, each providing specific performance data about the devices in the subscriber's network. The columns in main content area 504 include “Device Tag,” “Uptime,” “Active Network Interface,” “Reboot Frequency,” “Internet Disconnections,” “Internet Availability %,” “Streaming Interruptions,” and “Streaming Availability %.” This comprehensive set of metrics may provide technicians with a detailed overview of each device's performance and connectivity status. The “Device Tag” column may help quickly identify specific devices, while the “Uptime” column may indicate how long each device has been operational since its last reboot. The “Active Network Interface” column may show how each device is primarily connected to the network (e.g., Wi-Fi, Ethernet, MoCA), which may be helpful in diagnosing connection-related issues. “Reboot Frequency” may help identify devices that are experiencing stability issues, while “Internet Disconnections” and “Internet Availability %” may provide insights into the reliability of each device's internet connection. The “Streaming Interruptions” and “Streaming Availability %” columns may be particularly relevant for assessing the quality of video streaming services, a key concern for many subscribers of television services. In view of the above, in some examples, method 100 may include displaying, on the graphical user interface, software or firmware version information for each device in the subscriber's home network based on version data indicated in the network diagnostic information.

Below the main table in main content area 504, two smaller tables 506 and 508 are displayed, providing additional detailed information about network connections. Table 506 includes columns for “Device Tag,” “Internet Connection State,” “Connection Duration,” “Streaming Service State,” and “Streaming Duration.” Table 506 may offer a more granular view of each device's current connection status and the duration of its current state, which may be helpful in identifying intermittent issues or patterns in connection problems. Table 508 contains columns for “Device Tag,” “Network Interface,” “IP Assignment Status,” and “IP Lease Duration.” This information may be particularly useful for diagnosing issues related to IP address assignment or network interface configuration, which may impact a device's ability to connect to the internet or stream content effectively.

At the top of main content area 504, tab list 508 is displayed, labeled “Home Network Overview,” “Main Receiver,” “Secondary Receiver,” “Streaming Device 1,” and “Streaming Device 2.” The “Main Receiver” tab is highlighted, which can result in data from the tables below being highlighted if they are specific to the main receiver. Tab list 508 may enable technicians to quickly switch between different devices in the network, comparing their performance metrics and potentially identifying which device may be the source of reported issues. The ability to view detailed metrics for individual devices, as well as an overview of the entire home network, may provide technicians with the flexibility to perform both focused troubleshooting and broader network analysis as needed.

The level of detail provided in FIG. 5 may significantly enhance a technician's ability to diagnose and resolve complex network issues. For example, if a subscriber reports intermittent streaming problems, the technician may use the “Streaming Interruptions” and “Streaming Availability %” columns to identify which devices are experiencing the most issues. They may then correlate this information with the “Active Network Interface” and “Internet Availability %” data to determine if the problem is related to a specific type of network connection or a general internet connectivity issue. The “Reboot Frequency” column may reveal if any devices are unstable and requiring frequent restarts, which may indicate hardware problems or software conflicts. By providing this comprehensive set of metrics in a clear, tabular format, FIG. 5 may enable technicians to quickly identify patterns and anomalies that may not be apparent from less detailed network overviews. This depth of information may lead to more accurate diagnoses, faster problem resolution, and ultimately, improved customer satisfaction with the television service.

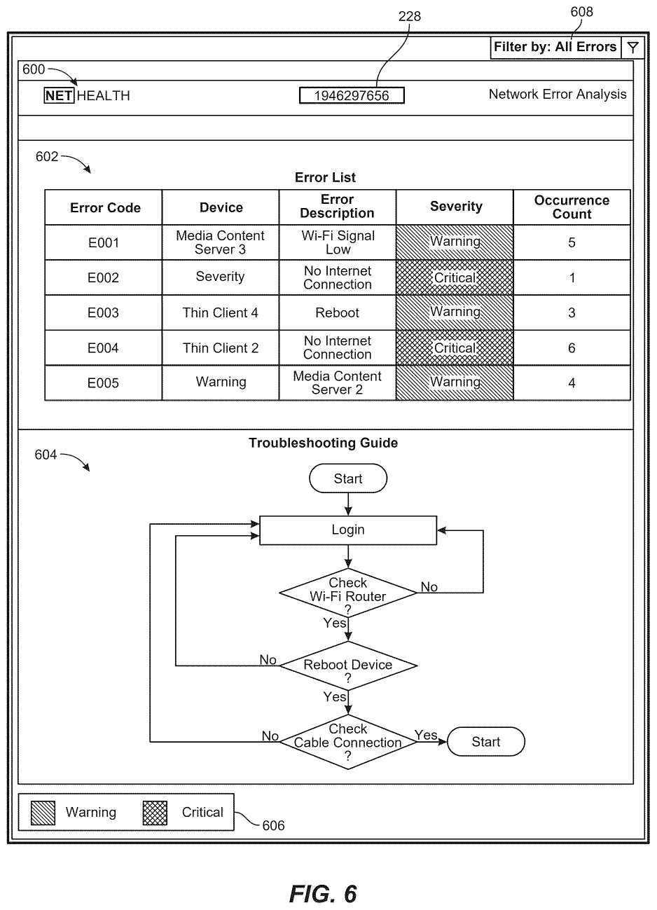

FIG. 6 presents a comprehensive network error analysis and troubleshooting view, combining a detailed list of current network errors with a guided troubleshooting process. This figure is divided into three main sections: header 600, error list 602, and troubleshooting guide 604. The layout of FIG. 6 is designed to provide technicians with a clear overview of ongoing network issues while simultaneously offering step-by-step guidance for resolving these problems, potentially streamlining the troubleshooting process and improving the efficiency of customer support interactions.

In header 600, a logo placeholder labeled “NET HEALTH” is prominently displayed at the top left, maintaining consistency with the branding seen in previous figures and immediately establishing the context of the diagnostic tool. Adjacent to the logo, text box 228 in header 600 contains the customer ID “1946297656”, ensuring that technicians can quickly verify they are viewing the correct subscriber's information. This consistent display of the customer ID across different views of the diagnostic tool may help prevent errors and confusion during troubleshooting sessions, particularly when technicians may be handling multiple cases in quick succession. On the right side of header 600, a title reading “Network Error Analysis” is displayed, clearly indicating the purpose and content of this particular view to the technician. This clear labeling may help technicians quickly orient themselves within the diagnostic tool, especially when switching between different views or modules during a support session.

Error list 602 forms a significant part of FIG. 6, presenting a detailed tabular view of current network errors. This table in error list 602 is structured with columns for “Error Code,” “Device,” “Error Description,” “Severity,” and “Occurrence Count.” The inclusion of error codes may enable for quick reference and categorization of issues, potentially enabling technicians to quickly identify common problems or cross-reference with known issue databases. The “Device” column in error list 602 may help pinpoint which specific components of the subscriber's network are experiencing problems, which may be particularly useful in complex home network setups with multiple devices. The “Error Description” column may provide more detailed information about the nature of each error, enabling technicians to understand the specific symptoms or manifestations of the problem. The “Severity” column in error list 602 may use color coding or other visual indicators (such as different shading patterns) to quickly highlight the most critical issues. For example, yellow shading may indicate warning-level issues, while red shading may denote critical problems that require immediate attention. This visual differentiation may help technicians prioritize their troubleshooting efforts, addressing the most pressing issues first. The “Occurrence Count” column may provide insight into how frequently each error is occurring, which may be valuable in distinguishing between intermittent glitches and persistent, systemic problems. This comprehensive list in error list 602 may serve as a central reference point for technicians, providing a clear and organized overview of the current state of the subscriber's network and any ongoing issues that may be addressed. In view of the above, in some examples, method 100 may include displaying, on the graphical user interface, a list of predefined error codes associated with alerts in the network topology representation, enabling the technician to identify specific types of alerts within the subscriber's home network.

Troubleshooting guide 604 of FIG. 6 presents a flowchart-style diagram showing steps to resolve the most critical error identified in error list 602. This visual representation of the troubleshooting process may provide technicians with a clear, step-by-step technique to address complex network issues. The flowchart in troubleshooting guide 604 may use simple shapes like rectangles for action steps and diamonds for decision points, creating a familiar and easily understandable format for guiding the troubleshooting process. Action steps in the flowchart may include instructions such as “Check Wi-Fi Router,” “Reboot Device,” or “Check Cable Connections.” These actionable steps may help ensure consistency in the troubleshooting process across different technicians and support sessions. Decision points in the troubleshooting guide 604 may ask questions like “Is the connection restored?” or “Are all cables securely connected?” with branches leading to different next steps based on the answers to these questions. This structured technique to troubleshooting may help technicians methodically work through potential solutions, reducing the likelihood of overlooking important steps or making errors in the diagnostic process. The visual nature of the flowchart in troubleshooting guide 604 may also make it easier for technicians to explain the troubleshooting process to subscribers, potentially improving communication and customer understanding of the steps being taken to resolve their issues. In view of the above, in some embodiments, method 100 may include generating and displaying, on the graphical user interface, a prompt for resolving a detected alert based on the network topology representation and the network diagnostic information. Moreover, in some embodiments, method 100 may further include displaying, on the graphical user interface, a list of error categories associated with detected alerts in the network topology representation, and providing, for each error category, a set of troubleshooting instructions that guides the technician through steps to resolve the associated alert.

At the bottom of FIG. 6, legend 606 is included to explain the severity color codes or shading patterns used in error list 602 and any symbols used in troubleshooting guide 604. Legend 606 may help ensure that technicians can quickly and accurately interpret the visual information presented in the figure, reducing the potential for misunderstandings or misinterpretations of the data. In the top-right corner of FIG. 6, filter dropdown menu 608 labeled “Filter by: All Errors” is displayed. This filtering option may enable technicians to focus on specific types of errors or specific devices, potentially streamlining the troubleshooting process for more targeted issue resolution. For example, a technician may choose to filter the error list to show only critical severity issues, or to display errors related to a specific device that the subscriber has reported problems with. This flexibility in viewing and organizing the error data may enhance the technician's ability to quickly identify and address the most relevant issues for each support case.

The combination of the error list 602 and troubleshooting guide 604 in FIG. 6 may significantly enhance a technician's ability to diagnose and resolve network issues efficiently. By providing both a comprehensive overview of current errors and a structured technique to address these issues, FIG. 6 may enable technicians to work through complex problems in a systematic manner. This technique may lead to faster problem resolution, more consistent troubleshooting across different support cases, and ultimately, improved customer satisfaction with the television service. Additionally, the clear presentation of error data and troubleshooting steps may facilitate better communication between technicians and subscribers, helping to explain the nature of network issues and the steps being taken to resolve them in a way that is more easily understood by non-technical users. Over time, the data collected through this error analysis and troubleshooting process may also prove valuable for identifying trends in network issues, informing proactive maintenance strategies, and guiding potential improvements to the television service infrastructure or customer support protocols.

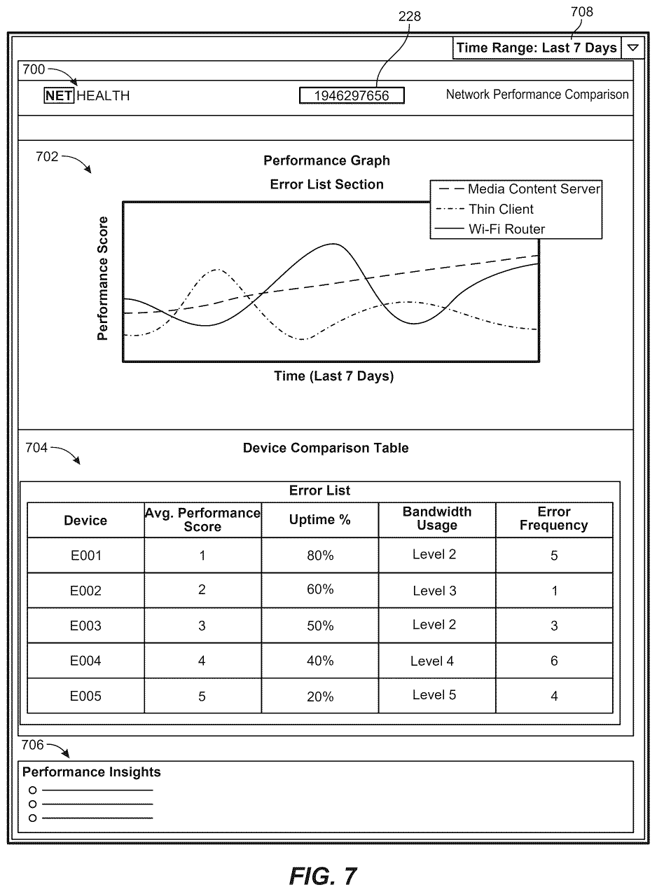

FIG. 7 presents a network performance comparison view, offering a comprehensive visualization of performance metrics across multiple devices in a subscriber's home network over time. The figure is divided into three main sections: header 700, performance graph 702, and device comparison table 704. This layout is designed to provide technicians with both a high-level overview of network performance trends and detailed device-specific metrics, potentially enabling more informed decision-making and efficient troubleshooting processes. In view of the above, in some examples, method 100 may include displaying, on the graphical user interface, a comparison between a current network topology representation and an ideal network topology for the subscriber's home network.

Header 700 maintains consistency with previous figures, featuring a logo placeholder labeled “NET HEALTH” at the top left, immediately establishing the context of the diagnostic tool. Adjacent to the logo, text box 228 in header 700 displays the customer ID “1946297656”, ensuring that technicians can quickly verify they are viewing the correct subscriber's information. This consistent presentation of the customer ID across different views may help prevent errors and confusion during troubleshooting sessions, particularly when technicians are handling multiple cases simultaneously. On the right side of header section 700, a title reading “Network Performance Comparison” is prominently displayed, clearly indicating the purpose and content of this particular view to the technician. This clear labeling may help technicians quickly orient themselves within the diagnostic tool, especially when switching between different views or modules during a support session. Header 700 sets the stage for the detailed performance data presented in the rest of the figure, providing context and ensuring that the technician is viewing the correct subscriber's information.

Performance graph 702 dominates the upper portion of FIG. 7, presenting a large line graph that visualizes network performance over time. The X-axis of this graph in performance graph 702 is labeled “Time (Last 7 Days)”, providing a clear timeframe for the displayed data and enabling technicians to identify both recent issues and longer-term trends. The Y-axis in performance graph 702 is labeled “Performance Score”, which may represent a composite metric derived from various aspects of network performance such as connection stability, throughput, and latency. This performance score technique may enable for a simplified, at-a-glance assessment of overall network health. Performance graph 702 features three different lines, each representing a different device in the subscriber's network. These devices may include, for example, the media content server, a thin client, and the Wi-Fi router. By overlaying the performance data for multiple devices on a single graph, technicians may be able to quickly identify discrepancies in performance between different components of the home network. This may be particularly useful for diagnosing issues that affect only certain devices or for identifying potential bottlenecks in the network infrastructure. The multi-device comparison in performance graph 702 may also help in correlating performance issues across different devices, potentially revealing systemic problems that affect the entire network rather than just individual components. A legend in the upper right corner of performance graph 702 explains which color corresponds to which device, ensuring clarity in the interpretation of the data presented.

Device comparison table 704 in the lower portion of FIG. 7 provides a more detailed breakdown of performance metrics for each device in the network. This table includes columns for “Device”, “Avg. Performance Score”, “Uptime %”, “Bandwidth Usage”, and “Error Frequency”. The “Device” column lists the names or types of devices being compared, corresponding to the lines in performance graph 702 above. The “Avg. Performance Score” column may provide a numerical representation of the overall performance for each device, enabling for quick comparisons between different components of the network. The “Uptime %” column may indicate the reliability of each device, with higher percentages suggesting more stable operation. “Bandwidth Usage” metrics may help identify devices that are consuming a disproportionate amount of network resources, which may be useful in diagnosing performance issues or planning network upgrades. The “Error Frequency” column may show how often each device encounters problems, potentially highlighting devices that may require closer attention or maintenance. This detailed tabular data in device comparison table 704 complements the visual representation in performance graph 702, providing specific numerical values that can be used for more precise analysis and comparison.

At the bottom of FIG. 7, Performance Insights 706 contains two to three bullet points of sample insights derived from the data presented in performance graph 702 and device comparison table 704. These insights may be generated automatically based on analysis of the performance data, potentially highlighting significant trends, anomalies, or areas of concern that the technician should be aware of. For example, an insight may note a consistent drop in performance for a specific device at certain times of day, or highlight a recent improvement in overall network stability following a configuration change. These automated insights may help guide the technician's analysis, drawing attention to important patterns or issues that may not be immediately apparent from the raw data alone.

In the top-right corner of FIG. 7, dropdown menu 708 labeled “Time Range: Last 7 Days” is displayed. This feature may enable technicians to adjust the timeframe of the data displayed in both the performance graph 702 and device comparison table 704. The ability to view different time ranges (e.g., last 24 hours, last 30 days, or custom date ranges) may provide flexibility in analyzing both short-term fluctuations and long-term trends in network performance. This time range selection feature may be particularly useful when investigating intermittent issues or assessing the impact of recent changes to the network configuration.

The combination of the visual performance graph 702, detailed comparison table 704, performance insights 706, and adjustable time range 708 in FIG. 7 may provide technicians with a powerful tool for analyzing and comparing network performance across multiple devices over time. This comprehensive view may enable more efficient and effective troubleshooting by enabling technicians to quickly identify performance discrepancies, correlate issues across devices, and recognize both short-term problems and long-term trends. The ability to compare performance across different devices may be particularly valuable in complex home network setups, where interactions between multiple components can lead to subtle or difficult-to-diagnose issues. By presenting this wealth of performance data in a clear, visually intuitive format, FIG. 7 may enhance technicians'ability to make data-driven decisions about network optimization, troubleshooting priorities, and potential hardware or configuration upgrades. This technique may lead to faster problem resolution, more proactive network management, and ultimately, improved customer satisfaction with the television service.

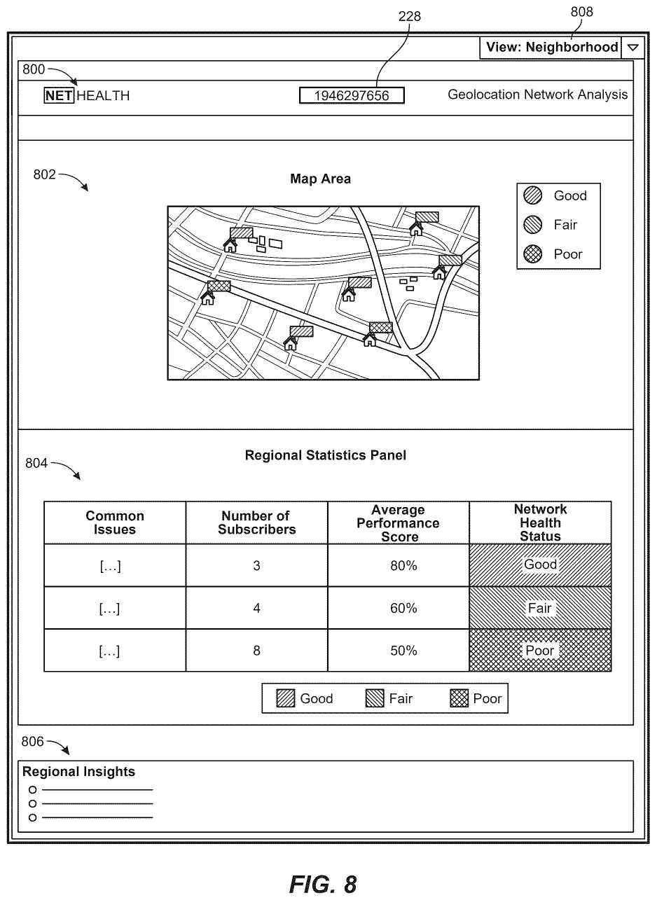

FIG. 8 presents a geolocation-based network analysis view, offering a comprehensive visualization of network performance across multiple subscribers in a specific geographic area. This figure is divided into three main sections: header 800, map area 802, and regional statistics panel 804. The layout of FIG. 8 is designed to provide technicians with both a broad overview of network health in a given area and detailed statistics about subscriber groups, potentially enabling more efficient identification of widespread issues and informed decision-making about network infrastructure improvements.

Header section 800 maintains consistency with previous figures, featuring a logo placeholder labeled “NET HEALTH” at the top left, immediately establishing the context of the diagnostic tool. Adjacent to the logo, text box 228 in header 800 displays the customer ID “1946297656”, ensuring that technicians can quickly verify they are viewing the correct subscriber's information. While this customer ID may be less relevant in a geolocation-based view that encompasses multiple subscribers, its inclusion maintains interface consistency and may serve as a reference point for the technician's current support session. On the right side of header 800, a title reading “Geolocation Network Analysis” is prominently displayed, clearly indicating the purpose and content of this particular view to the technician. This clear labeling helps technicians quickly orient themselves within the diagnostic tool, especially when switching between different views or modules during a support session. Header 800 sets the stage for the detailed geographical and statistical data presented in the rest of the figure, providing context and ensuring that the technician understands the nature of the information being displayed.

Map area 802 dominates the central portion of FIG. 8, presenting a simplified map of a residential area that includes streets and house outlines. This visual representation provides a clear geographical context for the network performance data being analyzed. Within map area 802, seven house icons are strategically placed, each representing a subscriber's location. These house icons use different shadings or patterns to represent different network health statuses. For example, a dark shading may indicate good network health, a medium shading may represent fair health, and a light shading or distinct pattern may signify poor network health. This visual coding enables technicians to quickly identify clusters of network issues or areas of consistently good performance. The use of a simplified map with clear iconography in map area 802 makes it easy for technicians to grasp the overall network health situation in the area at a glance, potentially enabling faster identification of localized issues or patterns. In the corner of map area 802, a legend is included to explain the meaning of the different shadings or patterns used for the house icons. This legend ensures that technicians can accurately interpret the visual information presented in the map, reducing the potential for misunderstandings or misinterpretations of the data.

Regional statistics panel 804 complements the visual map representation by providing detailed numerical data about network performance in the displayed area. This panel contains a table with columns for “Common Issues,” “Number of Subscribers,” “Average Performance Score,” and “Network Health Status.” The “Network Health Status” column may correspond to the shading categories used in map area 802, providing a text-based reference for the visual representations. The “Number of Subscribers” column quantifies how many subscribers fall into each health status category, giving technicians a clear understanding of the distribution of network issues in the area. The “Average Performance Score” column may provide a numerical representation of network health for each category, enabling for more precise comparisons between groups. The “Common Issues” column may list the most frequently occurring problems for each health status category, providing insight into the types of issues that are most prevalent in the area. This detailed statistical breakdown in regional statistics panel 804 enables technicians to move beyond the visual overview provided by the map and delve into specific metrics that can inform their analysis and decision-making processes.

At the bottom of FIG. 8, Regional Insights 806 contains two to three bullet points of sample observations about the area's network performance. These insights may be generated automatically based on analysis of the map data and regional statistics, potentially highlighting significant patterns, anomalies, or areas of concern that the technician should be aware of. For example, an insight may note a cluster of poor performance in a specific neighborhood, suggest a correlation between network health and distance from certain infrastructure points, or highlight a recent improvement in overall network stability following a system upgrade. These automated insights may help guide the technician's analysis, drawing attention to important patterns or issues that may not be immediately apparent from the raw data alone.

In the top-right corner of FIG. 8, dropdown menu 808 labeled “View: Neighborhood” is displayed. This feature may enable technicians to adjust the scope of the geographical area being analyzed. Options in this dropdown may include different levels of zoom, such as “Street,” “Neighborhood,” “City,” or “Region.” The ability to view network health data at different geographical scales may provide flexibility in analyzing both localized issues and broader regional trends. This scalability feature may be particularly useful when investigating issues that may have different root causes or manifestations at different geographical levels, such as local interference problems versus wide-area infrastructure limitations.

The combination of map area 802, regional statistics panel 804, regional insights 806, and dropdown menu 808 in FIG. 8 may provide technicians with a powerful tool for analyzing and comparing network performance across a geographical area. This comprehensive view may enable more efficient and effective troubleshooting by enabling technicians to quickly identify clusters of issues, correlate network health with geographical factors, and recognize both localized problems and broader regional trends. The ability to analyze network performance in a geographical context may be particularly valuable for identifying issues that affect multiple subscribers in an area, such as problems with shared infrastructure or environmental factors impacting signal quality. By presenting this wealth of geolocation-based data in a clear, visually intuitive format, FIG. 8 may enhance technicians' ability to make data-driven decisions about network optimization, troubleshooting priorities, and potential infrastructure improvements. This technique may lead to more targeted and efficient network maintenance, proactive problem-solving, and ultimately, improved customer satisfaction across the entire service area. Additionally, the insights gained from this geolocation-based analysis may inform strategic decisions about network expansions, upgrades, or reconfigurations to better serve subscribers in specific geographical areas.

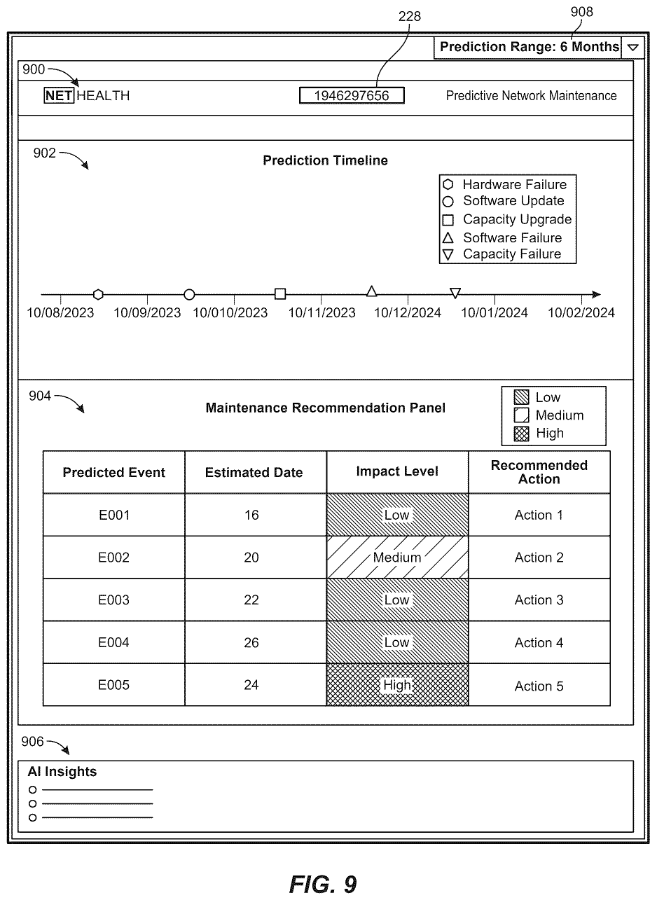

FIG. 9 presents a predictive network maintenance view, combining a visual timeline of predicted events with a detailed recommendation panel. This comprehensive display is designed to provide technicians with a forward-looking perspective on potential network issues and maintenance needs, enabling proactive management of the subscriber's home network.

Header 900 maintains consistency with previous figures, featuring a logo placeholder labeled “NET HEALTH” at the top left, establishing the context of the diagnostic tool. Adjacent to the logo, text box 228 in header 900 displays the customer ID “1946297656”, ensuring that technicians can quickly verify they are viewing the correct subscriber's information. On the right side of header 900, a title reading “Predictive Network Maintenance” is prominently displayed, clearly indicating the purpose and content of this particular view to the technician.

Prediction timeline 902 forms a central element of FIG. 9, presenting a horizontal timeline spanning the width of the page. Prediction timeline 902 is marked with dates, starting from the current date and extending 6 months into the future. This extended timeframe enables technicians to visualize both imminent and long-term potential issues or maintenance needs. Along prediction timeline 902, five icons are placed, each representing a predicted maintenance event or potential issue. As shown, these icons can use different shapes or shading patterns to represent different types of events, such as hardware failure predictions, software update requirements, or capacity upgrade recommendations. The visual representation of these predicted events on prediction timeline 902 enables technicians to quickly grasp the sequence and timing of potential network issues or maintenance needs.

Maintenance recommendation panel 904 complements prediction timeline 902 by providing detailed information about each predicted event. Maintenance recommendation panel 904 is structured as a table with columns for “Predicted Event,” “Estimated Date,” “Impact Level,” and “Recommended Action.” This tabular format in maintenance recommendation panel 904 enables technicians to quickly assess the nature, timing, and severity of each predicted issue, as well as view specific recommendations for addressing them. The “Predicted Event” column in maintenance recommendation panel 904 may provide a brief description of the anticipated issue or maintenance need, corresponding to the icons on prediction timeline 902. The “Estimated Date” column aligns with the positions of the icons on prediction timeline 902, providing specific timeframes for each prediction. The “Impact Level” column in maintenance recommendation panel 904 may use shading patterns to visually indicate the severity of each predicted event, enabling technicians to quickly prioritize their attention and resources. The “Recommended Action” column offers specific guidance on how to address or prepare for each predicted event, potentially improving the efficiency and effectiveness of network maintenance efforts.

At the bottom of FIG. 9, AI Insights 906 contains two to three bullet points of sample predictive insights about future network performance or maintenance needs. These insights in AI insights 906 may be generated by advanced analytics algorithms, leveraging historical data and machine learning to identify patterns and make predictions about the network's future state. The inclusion of these AI-driven insights in AI insights 906 may provide technicians with additional context and interpretation of the predicted events, potentially highlighting correlations or trends that may not be immediately apparent from the timeline and recommendation panel alone.

In the top-right corner of FIG. 9, dropdown menu 908 labeled “Prediction Range: 6 Months” is displayed. Dropdown menu 908 may enable technicians to adjust the timeframe of the predictions displayed in prediction timeline 902 and maintenance recommendation panel 904. This feature enables flexibility in focusing on short-term issues that may require immediate attention or long-term trends that may inform strategic planning and infrastructure investments.

The combination of prediction timeline 902, maintenance recommendation panel 904, AI insights 906, and dropdown menu 908 in FIG. 9 provides a powerful tool for proactive network management. By visualizing potential future issues and providing specific recommendations for addressing them, this predictive maintenance view may enable technicians to anticipate and prevent network problems before they impact the subscriber's experience. This technique may lead to improved network reliability, reduced downtime, and more efficient allocation of maintenance resources. Additionally, the long-term perspective provided by FIG. 9 may inform strategic decision-making about network upgrades, capacity planning, and technology adoption, potentially improving the overall quality and competitiveness of the television service over time.

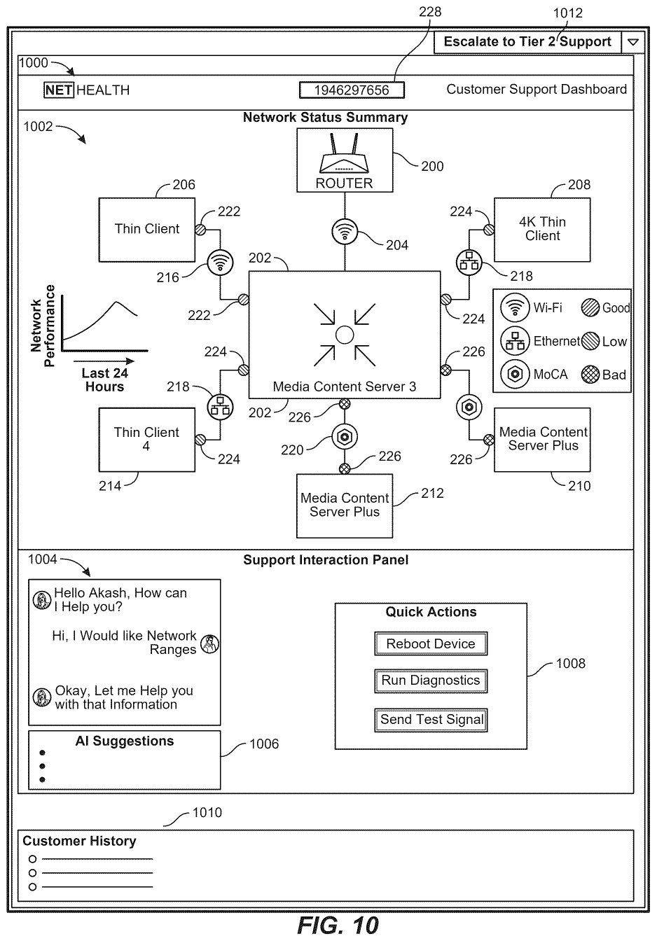

FIG. 10 illustrates an integrated customer support view that combines real-time network diagnostics with interactive support tools. This comprehensive display is designed to streamline the customer support process by providing technicians with immediate access to helpful network information, customer interaction capabilities, and automated assistance, all within a single interface.

Header 1000 maintains the consistent layout seen in previous figures, featuring a logo placeholder labeled “NET HEALTH” at the top left, establishing the context of the diagnostic tool. Adjacent to the logo, text box 228 in header 1000 displays the customer ID “1946297656”, ensuring that technicians can quickly verify they are viewing the correct subscriber's information. On the right side of header 1000, a title reading “Customer Support Dashboard” is prominently displayed, clearly indicating the purpose and content of this particular view to the technician.

Network status summary 1002 occupies the upper portion of FIG. 10, presenting a simplified version of the network topology from FIG. 2. Network status summary 1002 shows the main devices in the subscriber's home network, including the router, media content server, and thin clients. Each device in network status summary 1002 is color-coded or shaded to indicate its current status, with different patterns potentially representing good, warning (low), or error (bad) states. This at-a-glance view in network status summary 1002 enables technicians to quickly assess the overall health of the subscriber's network without needing to navigate to a separate topology view. Additionally, network status summary 1002 includes a small chart showing network performance over the last 24 hours, providing immediate context for any recent issues or fluctuations in network quality.

Support interaction panel 1004 forms the core of FIG. 10, divided into several key components designed to facilitate efficient customer support. On the left side of support interaction panel 1004, a chat-like interface is displayed, showing sample messages between a support agent and a customer. This chat interface in support interaction panel 1004 may include timestamps, message bubbles, and indicators of who is speaking, mimicking familiar messaging applications to create an intuitive interaction space. The inclusion of this chat interface directly alongside network diagnostic information enables technicians to maintain context during customer interactions, potentially improving the accuracy and efficiency of troubleshooting efforts.

On the right side of support interaction panel 1004, Quick Actions 1008 is prominently displayed. Quick actions 1008 contains buttons for common support actions such as “Reboot Device,” “Run Diagnostics,” and “Send Test Signal.” Quick actions 1008 in support interaction panel 1004 enable technicians to perform common troubleshooting steps directly from the interface, potentially reducing the time needed to resolve issues and improving the customer experience. The integration of these actions within support interaction panel 1004 enables technicians to implement solutions without needing to switch between different tools or interfaces. In view of the above, in some embodiments, method 100 may include enabling, through the graphical user interface, remote rebooting of specific devices displayed in the network topology representation.

Below the chat interface in support interaction panel 1004, AI Suggestions 1006 contains two to three bullet points of recommended actions or responses for the support agent. These AI-generated suggestions in support interaction panel 1004 may be based on the current network status, the content of the customer interaction, and historical data from similar support cases. By providing these automated suggestions, the system may help guide less experienced technicians, promote consistency in customer support, and potentially reduce the time needed to diagnose and resolve issues.

At the bottom of FIG. 10, “Customer History” 1010 is displayed, providing a brief summary of recent support interactions and network events. This historical context in customer history 1010 may help technicians understand any recurring issues or patterns in the subscriber's network performance, informing their approach to the current support interaction. The inclusion of customer history 1010 directly within support interaction panel 1004 eliminates the need for technicians to search through separate records or databases during customer interactions.

In the top-right corner of FIG. 10, dropdown menu 1012 labeled “Escalate to Tier 2 Support” is prominently displayed. dropdown menu 1012 provides a clear and immediate way for technicians to escalate complex issues to more experienced support staff when necessary. The presence of this escalation option directly within the main support interface may help ensure that challenging problems are addressed efficiently, potentially improving customer satisfaction and reducing frustration for both subscribers and support staff.

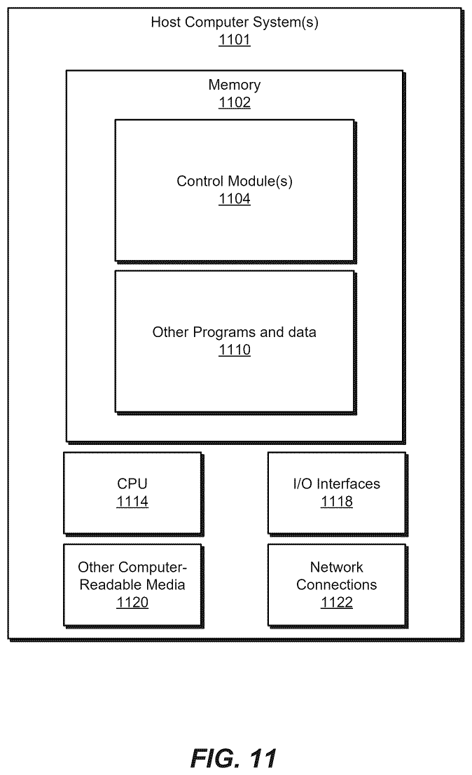

FIG. 11 shows a system diagram that describes an example implementation of a computing system(s) for implementing embodiments described herein. The functionality described herein can be implemented either on dedicated hardware, as a software instance running on dedicated hardware, or as a virtualized function instantiated on an appropriate platform, e.g., a cloud infrastructure. In some embodiments, such functionality may be completely software-based and designed as cloud-native, meaning that they are agnostic to the underlying cloud infrastructure, enabling higher deployment agility and flexibility. However, FIG. 11 illustrates an example of underlying hardware on which such software and functionality may be hosted and/or implemented.

In particular, shown is example host computer system(s) 1101. For example, host computer system(s) 1101 may execute a scripting application, or other software application, as further discussed above, and/or to perform one or more of the other methods described herein. In some embodiments, one or more special-purpose computing systems may be used to implement the functionality described herein. Accordingly, various embodiments described herein may be implemented in software, hardware, firmware, or in some combination thereof. Host computer system(s) 1101 may include memory 1102, one or more central processing units (CPUs) 1114, I/O interfaces 1118, other computer-readable media 1120, and network connections 1122.

Memory 1102 may include one or more various types of non-volatile and/or volatile storage technologies. Examples of memory 1102 may include, but are not limited to, flash memory, hard disk drives, optical drives, solid-state drives, various types of random access memory (RAM), various types of read-only memory (ROM), neural networks, other computer-readable storage media (also referred to as processor-readable storage media), or the like, or any combination thereof. Memory 1102 may be utilized to store information, including computer-readable instructions that are utilized by CPU 1114 to perform actions, including those of embodiments described herein.

Memory 1102 may have stored thereon control module(s) 1104. Control module(s) 1104 may be configured to implement and/or perform some or all of the functions of the systems or components described herein. Memory 1102 may also store other programs and data 1110, which may include rules, databases, application programming interfaces (APIs), software containers, nodes, pods, clusters, node groups, control planes, software defined data centers (SDDCs), microservices, virtualized environments, software platforms, cloud computing service software, network management software, network orchestrator software, network functions (NF), artificial intelligence (AI) or machine learning (ML) programs or models to perform the functionality described herein, user interfaces, operating systems, other network management functions, other NFs, etc.

Network connections 1122 is configured to communicate with other computing devices to facilitate the functionality described herein. In various embodiments, network connections 1122 include transmitters and receivers (not illustrated), cellular telecommunication network equipment and interfaces, and/or other computer network equipment and interfaces to send and receive data as described herein, such as to send and receive instructions, commands and data to implement the processes described herein. I/O interfaces 1118 may include a video interface, other data input or output interfaces, or the like. Other computer-readable media 1120 may include other types of stationary or removable computer-readable media, such as removable flash drives, external hard drives, or the like.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method comprising:
extracting, by a server of a television service operator, network diagnostic information from network messages received over a wide area network from a plurality of devices within a subscriber's home network that includes at least one media content server and a set of media content clients that are connected to the wide area network through a home router such that the server generates, based on the extracted network diagnostic information, a network topology representation of the subscriber's home network that includes graphical representations of the plurality of devices and connections between the devices and that includes status indicators for each of the devices and connections based on the extracted network diagnostic information; and
displaying, on a graphical user interface of a computing device used by a technician of the television service operator to assist the subscriber, the network topology representation that was generated based on the extracted network diagnostic information as extracted from the network messages received over the wide area network such that the television service operator is enabled to prevent or remediate a network connectivity alert within the subscriber's home network based on the displayed network topology representation.

2. The method of claim 1, further comprising displaying, on the graphical user interface, changes to the network topology representation in real-time based on newly received network messages from the plurality of devices within the subscriber's home network.

3. The method of claim 1, further comprising displaying, on the graphical user interface, a historical view of the network topology representation over a specified time period that shows changes in the status indicators for the devices and connections over time.

4. The method of claim 1, further comprising highlighting, in the network topology representation, specific devices or connections with detected alerts based on predetermined error codes indicated in the network diagnostic information.

5. The method of claim 4, further comprising displaying, in response to a selection of a highlighted device or connection, additional diagnostic information for the selected device or connection.

6. The method of claim 1, further comprising displaying, on the graphical user interface, a list of predefined error codes associated with alerts in the network topology representation such that the technician is enabled to identify specific types of alerts within the subscriber's home network.

7. The method of claim 1, further comprising displaying, in the network topology representation, signal strength indicators for wireless connections between devices based on signal strength data indicated in the network diagnostic information.

8. The method of claim 1, further comprising displaying, in the network topology representation, connection type indicators that specify whether each connection between devices is a Wi-Fi connection, an Ethernet connection, or a MoCA connection.

9. The method of claim 1, further comprising generating and displaying, on the graphical user interface, a prompt for resolving a detected alert based on the network topology representation and the network diagnostic information.

10. The method of claim 1, further comprising displaying, in the network topology representation, bandwidth usage information for each device and connection based on bandwidth data indicated in the network diagnostic information.

11. The method of claim 1, further comprising displaying, on the graphical user interface, software or firmware version information for each device in the subscriber's home network based on version data indicated in the network diagnostic information.

12. The method of claim 1, further comprising providing, on the graphical user interface, a search function that enables the technician to locate specific devices within the network topology representation based on device identifiers indicated in the network diagnostic information.

13. The method of claim 1, further comprising displaying, on the graphical user interface, a history of recent changes to a network configuration of the subscriber's home network based on configuration change data indicated in the network diagnostic information.

14. The method of claim 1, further comprising displaying, on the graphical user interface, a comparison between a current network topology representation and an ideal network topology for the subscriber's home network.

15. The method of claim 1, further comprising enabling, through the graphical user interface, remote rebooting of specific devices displayed in the network topology representation.

16. The method of claim 1, further comprising displaying, on the graphical user interface, a list of error categories associated with detected alerts in the network topology representation; and
providing, for each error category, a set of troubleshooting instructions that guides the technician through steps to resolve the associated alert.

17. A non-transitory computer-readable medium that has instructions stored thereon that, when executed by at least one physical computing processor, cause a computing device to perform operations comprising:
extracting, by a server of a television service operator, network diagnostic information from network messages received over a wide area network from a plurality of devices within a subscriber's home network that includes at least one media content server and a set of media content clients that are connected to the wide area network through a home router such that the server generates, based on the extracted network diagnostic information, a network topology representation of the subscriber's home network that includes graphical representations of the plurality of devices and connections between the devices and that includes status indicators for each of the devices and connections based on the extracted network diagnostic information; and
displaying, on a graphical user interface of a computing device used by a technician of the television service operator to assist the subscriber, the network topology representation that was generated based on the extracted network diagnostic information as extracted from the network messages received over the wide area network such that the television service operator is enabled to prevent or remediate a network connectivity alert within the subscriber's home network based on the displayed network topology representation.

18. The non-transitory computer-readable medium of claim 17, wherein the operations further comprise displaying, on the graphical user interface, changes to the network topology representation in real-time based on newly received network messages from the plurality of devices within the subscriber's home network.

19. A system comprising:
at least one physical computing processor of a computing device; and
a non-transitory computer-readable medium that has instructions stored thereon that, when executed by the at least one physical computing processor, cause the computing device to perform operations comprising:
extracting, by a server of a television service operator, network diagnostic information from network messages received over a wide area network from a plurality of devices within a subscriber's home network that includes at least one media content server and a set of media content clients that are connected to the wide area network through a home router such that the server generates, based on the extracted network diagnostic information, a network topology representation of the subscriber's home network that includes graphical representations of the plurality of devices and connections between the devices and that includes status indicators for each of the devices and connections based on the extracted network diagnostic information; and
displaying, on a graphical user interface of a computing device used by a technician of the television service operator to assist the subscriber, the network topology representation that was generated based on the extracted network diagnostic information as extracted from the network messages received over the wide area network such that the television service operator is enabled to prevent or remediate a network connectivity alert within the subscriber's home network based on the displayed network topology representation.

20. The system of claim 19, wherein the operations further comprise displaying, on the graphical user interface, changes to the network topology representation in real-time based on newly received network messages from the plurality of devices within the subscriber's home network.
